(19) United States
(12) Patent Application Publication
(10) Pub. No.: US 2014/0074922 A1
(43) Pub. Date: Mar. 13, 2014

(54) REAL-TIME NOTIFICATION OF INCREASED COMMUNICATION IN A SELECTED AREA OF INTEREST(S) ON A SOCIAL NETWORKING SYSTEM

(71) Applicant: Christopher David Bell, Athens, GA (US)

(72) Inventor: Christopher David Bell, Athens, GA (US)

(21) Appl. No.: 13/610,461

(22) Filed: Sep. 11, 2012

(51) Int. Cl. G06F 15/16

(52) U.S. Cl. 709/204

(57) ABSTRACT

Systems and methods for providing real-time notification of increased communication in a selected area of interest(s) on a social networking system. A plurality of resource objects are maintained on a social networking system. A resource display interface is provided on a communications device of a user. The social networking system continuously monitors resource object associations. The social networking system identifies changes in resource object associations and mean traffic data for a particular resource object. The resource display interface is updated to display additional changes in resource object associations. The social networking system determines whether mean traffic data on the social networking system for a particular resource object exceeds a threshold established by user filter data. A real-time signal is transmitted indicating that changes in activity on the social networking system for a particular resource object exceeds the threshold established by user filter data.

### CROSS REFERENCE TO RELATED APPLICATIONS

This application contains subject matter related to subject matter contained in co-pending U.S. Ser. No. 13/610,428 (docket ECSTT01) filed on Sep. 11, 2012 and incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction anyone of the patent disclosure as it appears in the Patent and Trademark Office patent files or records, but otherwise reserves all copyright and trade dress rights whatsoever.

### BACKGROUND

Social networking systems may communicate connections amongst users sharing common interests or activities. Such social networking systems are accessible to users by computer or other device. Social networking systems are most often web-based. Such social networking systems may allow users to interact, such as by emails, posting blogs, posting comments, or photos to other users.

Users on social networking systems can create associations, such as events, or groups which can be stored on social networking systems. Other users can view events of friends or contacts. However, users must often be associated with other users or perform a search to view such events or groups. Moreover, communication of increased activity and real-time traffic data may not available to other non-associated users. It is desirable for users to obtain information related to events, groups, or establishments pertaining to selected areas of interest areas for such users. It is also desirable to provide real-time communications of increased activity pertaining to events, groups, or establishments the user has chosen to associate with.

For example, a user on the social networking system may wish to attend a football game and associated events in another location. The user may be associated with football game, and event, but may not be associated with some of the other users hosting related events. It would be desirable for the user to view and associate with events related to this interest independent of other user associations, and to be provided with aggregate traffic data representing a change in such activities based on the user's preferences. In the example, a user could be notified of related game-day events and receive a real-time signal indicating increased/decreased activities relating to such activities if a user specified a high interest level in such related events. Accordingly, a need exists for providing real-time notification of increased communication in a selected area of interest(s) on a social networking system.

### SUMMARY

The present invention is directed to systems and methods of providing real-time notification of increased communication in a selected area of interest(s) on a social networking system. A user of a social networking system can choose to associate with a number of resource objects (events, groups, establishments, or other users) maintained on the social networking system. The user designates an interest level for each resource object the user has chosen to associate with. A threshold level indicating a rate of change in other user activity is established for each resource object the user chooses to associate with. The threshold level is inversely related to the interest level.

Resource objects can be associated with any number of other resource objects. A resource display interface is provided on a communications device (e.g., computer, mobile device, tablet, smart phone, television, etc. . . . ) of a user comprising a scalable tessellation of resource objects a user has chosen to associate with. The resource display interface is capable of indicating the number of associations between resource objects. The resource display interface is also capable of transmitting a signal to a user of increased communication exceeding the threshold established for each resource object the user has chosen to associate with.

The social networking system continuously monitors network activity on the social networking system. The social networking system identifies changes in the number of associations between resource objects. The social networking system also identifies changes in mean traffic data for a particular resource object on the social networking system. The resource display interface is updated to graphically display additional resource object associations. The social networking system determines whether mean traffic data on the social networking system for a particular resource object exceeds a threshold established by user filter data. A real-time signal is transmitted to a communications device of a user indicating that changes in activity on the social networking system for a particular resource object which exceeds the threshold established by user filter data. Such a real-time signal may be a flashing or blinking indication on the resource display interface.

In application, the social networking system provides real-time representation of other user activity on resource objects on the social networking system via the resource display interface. Each of such resource objects is represented on the resource display interface. Resource objects can be associated with other resource objects on the social networking system. The number of associations between each resource object is displayed on the resource display interface which may allow a user to view related interests. Other user activity on the social networking system exceeding a threshold triggers a real-time signal displayed on the resource display interface. Therefore, the user could be alerted of real-time activity according to their interest level in each resource object.

Conceptually, the social networking system embodies some of the attributes of abstract swarm intelligence (SI). SI refers to the collective behavior of non-centralized organizations. In nature, certain biological species exhibit SI, resulting in global behavior. For example, individual bees in a colony may signal the presence of a natural resource to other members of the colony through a predetermined series of movements. Such movements have been referred to as a “waggle dance.” In a typical “waggle dance,” an individual bee may move in 100 or more circuits. The direction and duration of the circuit are closely correlated with the direction and distance of the resource being advertised by the dancing bee. In this manner, other members of the colony are notified of the nature and direction of the resource, and may act accordingly.

The social networking system analyzes the aggregate behavior of individual users to signal users in real-time. Increased activity (relevant to a user's preferences) may signal that a resource is desirable to a particular user.

### BRIEF DESCRIPTION OF THE DRAWINGS

These and other features, aspects and advantages of embodiments of the invention will become better understood with regard to the following description, appended claims, and accompanying drawings where:

FIG. 1 is a flow diagram of an exemplary process for providing real-time notification of increased communication in a selected area of interest(s) on a social networking system;

FIG. 2 is a relationship diagram showing supplied data defining a resource object on the social networking system;

FIG. 3 illustrates information stored in user filter data on the social networking system;

FIG. 4 illustrates information stored in a resource object maintained on the social networking system;

FIGS. 5-6 illustrate exemplary resource display interfaces displayed on a communications device of a user of the social networking system;

FIG. 7 illustrates an exemplary resource display interface with a resource traffic indicia signaling member on the resource display interface displayed on a communications device of a user of the social networking system;

FIG. 8 is a high-level diagram of an exemplary system for providing real-time notification of increased communication in a selected area of interest on a social networking system showing interaction between communications devices of a host, partner, and user with a social networking system;

FIG. 9 is a schematic diagram of an exemplary social networking system;

FIG. 10 is a schematic diagram of detailed view of an exemplary hardware implementation of the social networking system;

FIG. 11 illustrates an example of a social networking system maintaining resource objects;

FIG. 12 illustrates an example of a social networking system providing a resource display interface on a communications device of a user;

FIG. 13 illustrates an example of a social networking system continuously monitoring resource object associations and mean traffic data for resource objects on the social networking system;

FIG. 14 illustrates an example of a social networking system identifying changes in resource object associations and mean traffic data for a particular resource object;

FIG. 15 illustrates an example of a social networking system updating a resource display interface to display additional resource object associations on a communications device of a user on the social networking system;

FIG. 16 illustrates an example of a social networking system determining whether mean traffic data on the social networking system for a particular resource object exceeds a threshold established by user filter data;

FIG. 17 illustrates an example of a social networking system transmitting a real-time signal to the communications device of a user on the social networking system;

FIG. 18 illustratively shows a social networking system allowing a user to navigate to a selected resource object on the social networking system;

FIG. 19 is an exemplary screenshot of a user event display interface displayed on a communications device of a user of the social networking system; and

FIG. 20 is a flow diagram of an exemplary process for providing real-time notification of increased communication in a selected area of interest(s) on a social networking system according to an alternate embodiment.

### DESCRIPTION

### Overview

Embodiments provide systems and methods of providing real-time notification of increased communication in a selected area of interest(s) on a social networking system. The social networking system maintains a plurality of resource objects on the social networking system. The social networking system provides a resource display interface on a communications device (e.g., computer, mobile device, tablet, smart phone, television, etc. . . . ) of the user. The social networking system continuously monitors resource object associations and mean traffic data for resources objects on the social networking system. The social networking system identifies changes in resource object associations and mean traffic data for a particular resource object. The resource display interface is updated to display additional resource object associations. The social networking system determines whether mean traffic data on the social networking system for a particular resource object exceeds a threshold established by user filter data. A real-time signal is transmitted to a communications device of a-user indicating that changes in mean traffic data on the social networking system for a particular resource object exceeds the threshold established by user filter data.

### Definitions

Resource objects herein refer to data objects pertaining to events, groups, establishments, and other users on the social networking system. Resource objects may include resource information, amended resource data, content data, and resource object associations. Resource objects can be classified by type. For example, resource objects may be event types, bar types, restaurant types, and/or retail store types. Each type may be further subdivided into a class. Examples of classes of resource objects may include tail-gate, bar, play-off, wedding, seminar, wine bar, fraternity, and the like.

Resource objects can be associated with other resource objects on the social networking system. For example, an event may be associated with establishments, events, or groups relevant to the event. Resource objects can also be associated with sub-resources. For example, an event could have a sub-event. Resource objects may maintain a horizontal and/or vertical relationship with other resource objects on the social networking system.

A user can interact with the social networking system through a communications device and choose to be a host of a resource object. The host creates an event, group, or establishment on the social networking system and provides resource information relevant to the particular resource object.

A user can interact with the social networking system through a communications device and can also choose to be a partner of a resource object. One or more partners can associate with the resource object. A partner can access resource objects after creation by the host, and may provide amended resource information about a particular group, event, or establishment. In the example of an establishment, a partner may be an owner/operator of the establishment.

Resource information refers to data relevant to the event, group, or establishment, provided by the host. Resource information for example can be an event name, an event start date, event end date, and similar information. Resource information also contains information detailing how the website generated by the web-based templates is to be displayed to an end-user. For example, a host can select the number and type real-time interface components including of widgets, chat applications, or posting message boards which can be displayed on the websites generated by the web-based templates.

Amended resource information refers to data relevant to the event, group, or establishment, provided by a partner. Amended resource information can be menu information, a logo image, coupons, and hours of operation in the case of a restaurant (establishment) resource object.

Content data refers to real-time data provided by users relating to the resource object. Content data may include for example video or audio clips, images, comments, status messages, blog entries, URL links, and/or ratings and reviews. Content data is transmitted by the user from the user's originating communication device to the social networking system.

User resource object associations herein refer to data objects representing the numerical value of resource objects a user has chosen to be associated with. For example, a user may choose to follow a football game watch party (event), a fraternity (group), and Italian restaurant (establishment). The number of user resource object associations would be three (3).

User filter data herein refers to data objects representing the relationship of the resource objects the user has chosen to associate with and the corresponding importance level the user has assigned to each resource object. For example, a user may specify the importance of each resource object on a scale of 1 to 10 (with 1 being the least important and 10 being the most important). The resource objects and corresponding importance level may be associated by a one or more linked lists or other data structures on the social networking system.

A threshold herein represents a minimum change in mean traffic data for a particular resource which must be exceeded for notification to the user. The threshold is inversely related to the level of importance assigned by the user and is represented by a percentage of change. For example, if a user assigned an importance of 8 of 10 to a particular resource object, the threshold may be defined as Δ10%. Conversely, if a user assigned an importance of 2 of 10 to a particular resource object, the threshold may be defined as Δ70%.

Mean traffic data represents user activity for a class of resource objects over a given period of time. User activity includes content data, resource information, and amended resource data. To determine mean traffic data, the social networking system determines the mean traffic data by class of resource objects over the given time period. For example, the social networking system may have five (5) resource objects of a particular class on the social networking system. If the total user activity for the five (5) resource objects totals two-hundred activities per second (200/s), then the mean traffic data for the class or resource objects would be forty activities per second (40/s).

### Detailed Description of the Elements

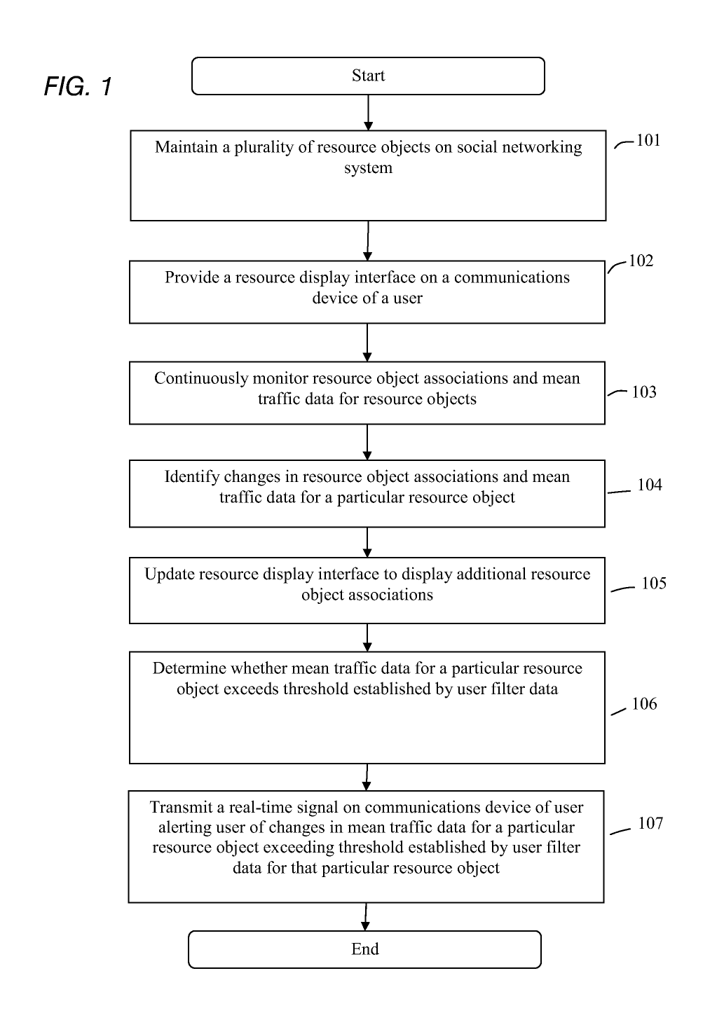

FIG. 1 illustrates a method of providing real-time notification of increased communication in a selected area of interest on a social networking system 201. A plurality of resource objects 202 are maintained 101 on a social networking system 201. A resource display interface 120 is provided 102 on a communications device 205a (e.g., computer, mobile device, tablet, smart phone, television) of a user. The social networking system 201 continuously monitors 103 resource object associations 714 and mean traffic data on the social networking system 201. The social networking system 201 identifies changes 104 in resource object associations 714 and mean traffic data for a particular resource object 202 on the social networking system 201. The resource display interface 120 is updated to display 105 additional resource object associations 714. The social networking system 201 determines 106 whether mean traffic data on the social networking system 201 for a particular resource object 202 exceeds a threshold established by user filter data 715. A real-time signal is transmitted 107 to a communications device of 205a of a end-user indicating that changes in activity on the social networking system 101 for a particular resource object 202 which exceeds the threshold established by user filter data 715.

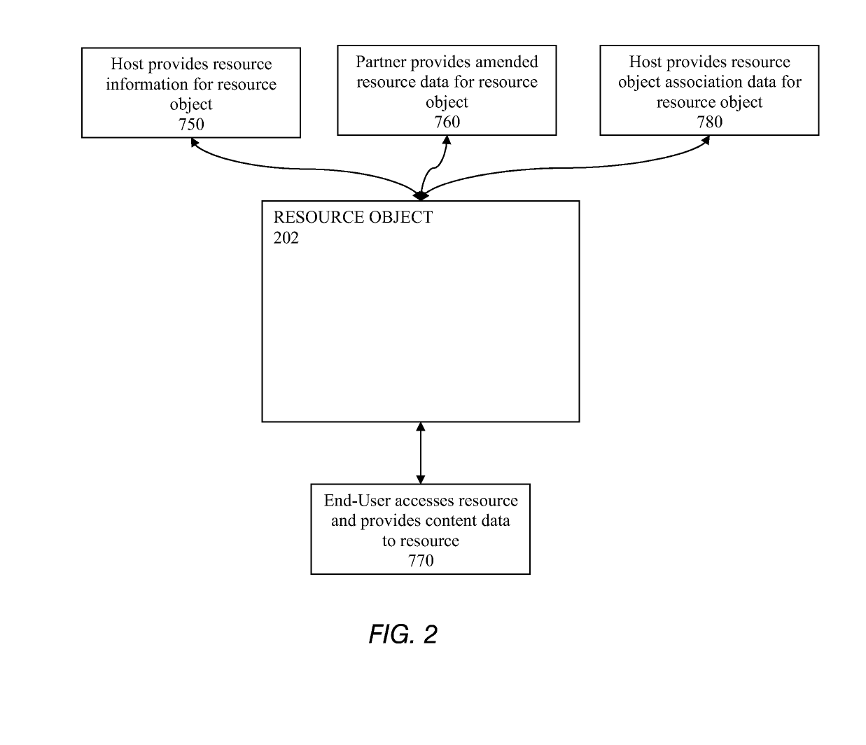

FIG. 2 illustrates a relationship diagram showing supplied data defining a resource object 202 on the social networking system 201. As shown, the host provides resource information 713 at 750. A partner provides amended resource information 712 at 760. A user accesses the resource object 202 and provides content data 711 at 770. The host can choose to associate the resource object 202 with other resource objects maintained on the social networking system 201 at 780.

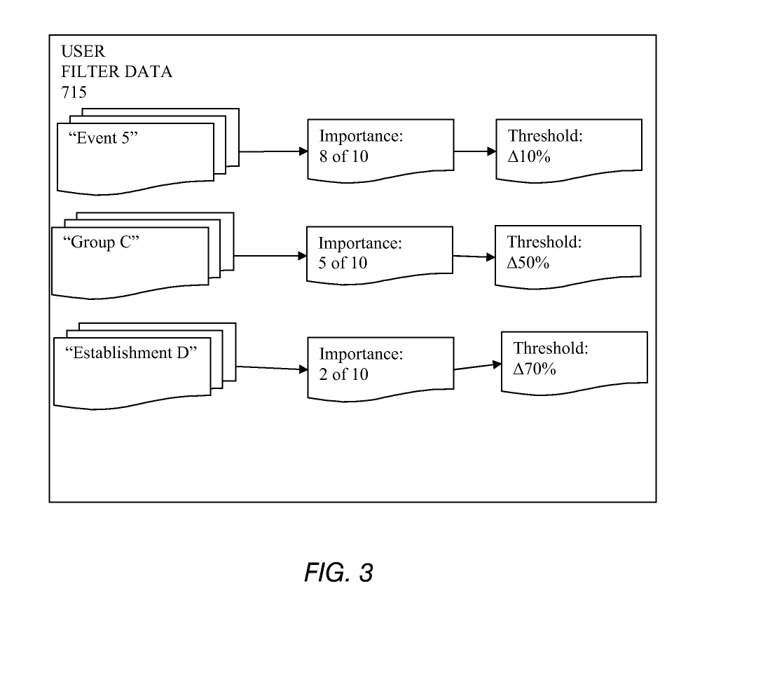

FIG. 3 illustrates information stored in user filter data 715. The user chooses to associate with a number or resource objects 202 on the social networking system 201. The numerical value is stored as user resource associations. The user assigns an importance to each resource object he has chosen to associate with. A threshold is generated indicating a minimum change in mean traffic data for a particular resource. The threshold is inversely proportional to the importance level assigned by the user.

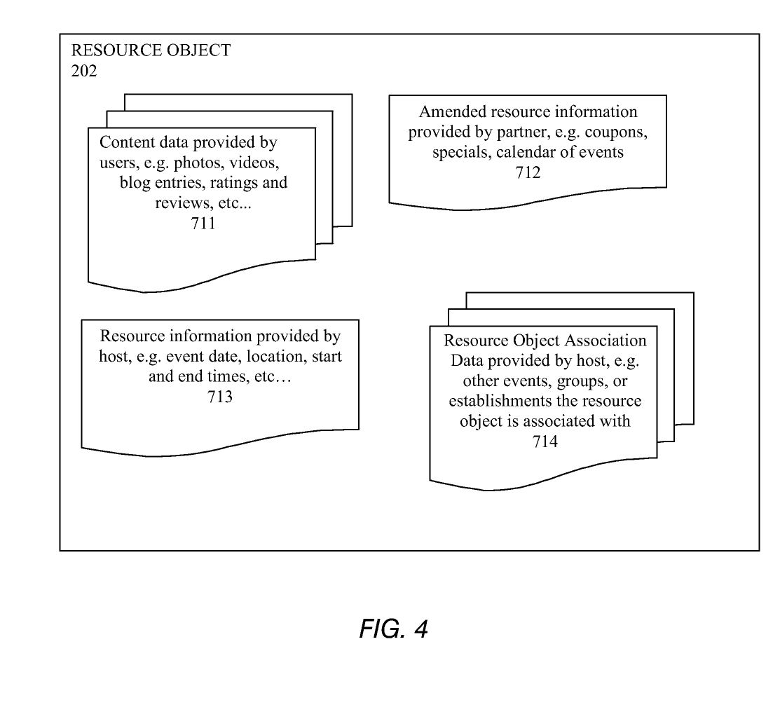

FIG. 4 illustrates information stored in a resource object 202 maintained 101 on the social networking system 201. As shown, resource objects 201 are comprised of content data 711, amended resource information 712, resource information 713, and resource object associations 714.

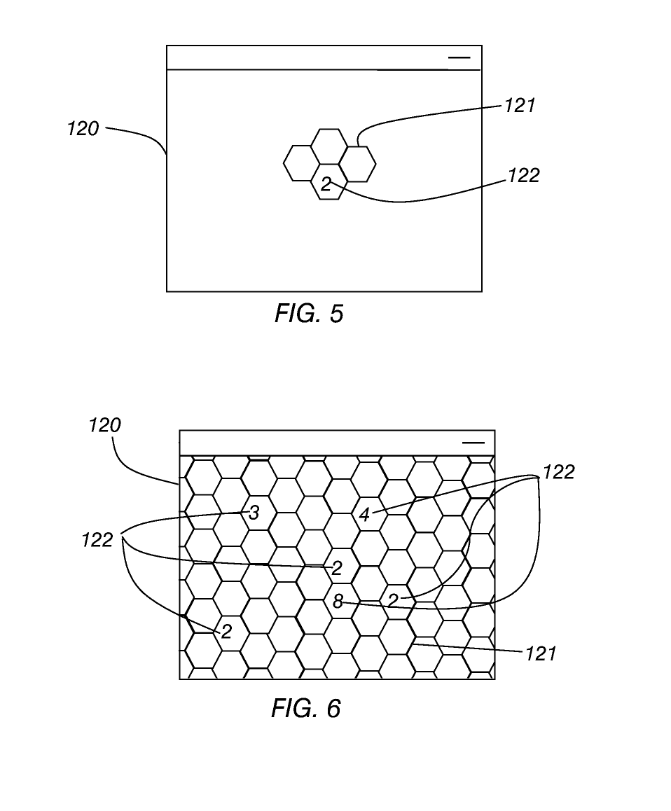

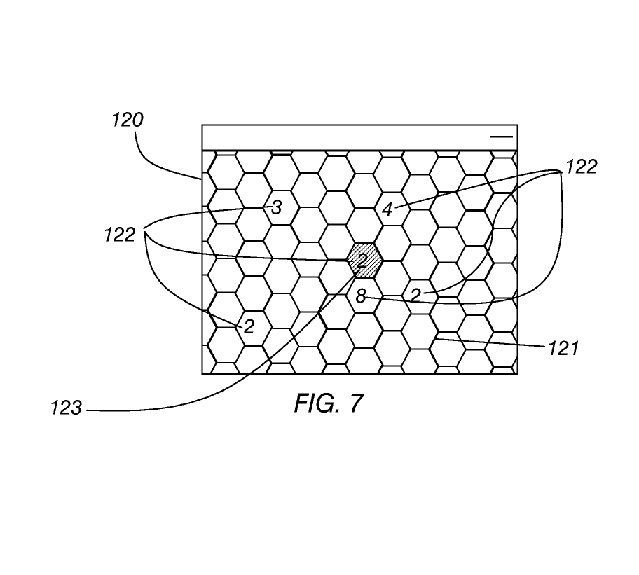

FIGS. 5-7 illustrate a resource display interface 120 provided 102 on a communications device of a user 205a. A resource display interface 120 is a graphical user interface. The resource display interface 120 is a scalable tessellation of one or more resource display members 121. Resource display members 121 are graphically displayed to the user, with a number of sides and vertices. As shown in FIGS. 5-7, resource display members 121 are displayed as honeycomb cells, with six sides and vertices. Resource display members 121 represent resource objects 202 the user has chosen to associate with. As the number of resource objects 202 increases for a particular user, more resource display members 121 are displayed. For example, FIG. 5 shows a resource display interface in which a user has with four (4) user resource associations. Other users may have more resource display members 121, based on an accumulation of resource objects, as shown in FIGS. 6-7.

Resource association indicators 122 are displayed on one or more resource display members. Resource association indicators 122 represent the number of resource object associations 714 for each resource object 202. For example, resource display indicator 122 in FIG. 5 shows a resource object 202 associated with two (2) other resource objects 202 on the social networking system 201.

The social networking system 201 continuously monitors 103 resource object associations 714 and mean traffic data for resource objects 202 on the social networking system 201. Monitoring occurs real-time on the social networking system 201.

The social networking system 201 identifies 104 changes in resource object associations 714 and mean traffic data for resource objects 202 on the social networking system 202. Changes in resource object associations 714 are represented as a numerical value. Changes in mean traffic data for a particular resource object 202 are represented by a percentage of change. For example, if mean traffic data was determined to be forty activities (which may include updated posting of resource information, updated posting of amended resource information, posts, blog entries, posted photos) per second (40/s), then a detection of sixty activities per second (60/s) for a particular resource object 202 would correspond with a Δ50% in mean traffic data for that particular resource object 202.

The social networking system 201 updates 105 the resource display interface 120 to display additional resource object associations 714. For example, if a particular resource object 202 was previously associated with two (2) groups, and another association was added for a particular resource object, then the resource association indicator 122 would be updated to display the number three (3).

The social networking system 201 determines 106 whether the change in mean traffic data for a particular resource object 202 exceed the threshold established by user filter data 715. For example, if a threshold was determined to be Δ10% by user filter data 715, then Δ50% in mean traffic data for a particular resource object 202 would exceed the threshold for that particular resource object 202.

FIG. 7 shows a real-time signal transmitted 107 to a communications device of a user 205a indicating that changes in activity on the social networking system 201 for a particular resource object 202 exceeds the threshold established by user filter data 715. As shown in FIG. 7, the real-time signal is communicated via a traffic indicia signaling member 123 displayed on one or more of the resource display members 121. Each resource traffic indicia signaling member 123 may provide visual notification to the communications device of the user 205a by flashing or other means.

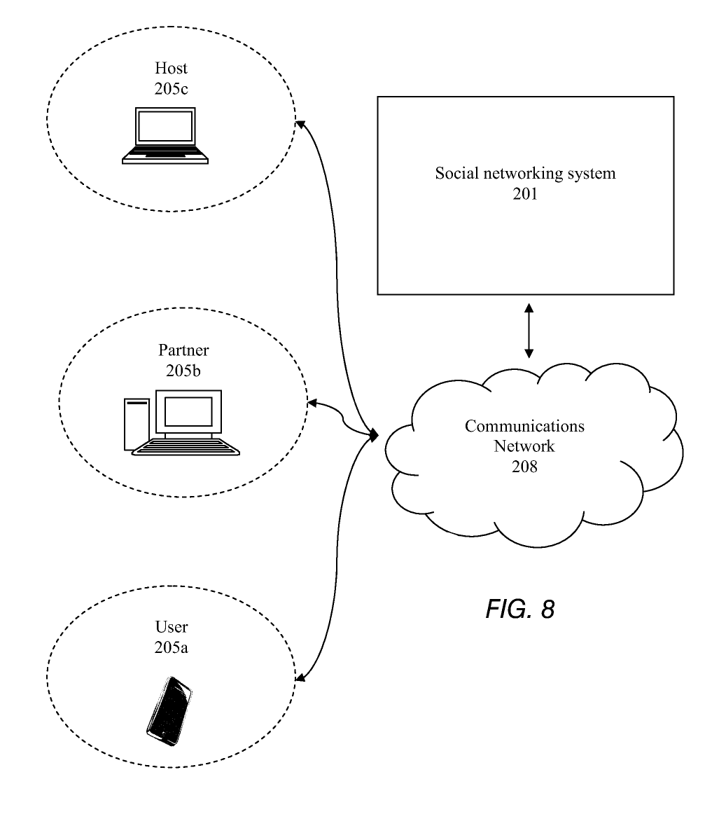

FIGS. 8-10 illustrate a system for providing real-time notification of increased communication in a selected area of interest(s) on a social networking system 201. Several of the functional components described are labeled as modules (e.g. modules 154, 156) in order to more particularly emphasize their implementation independence. For example, a module may be implemented as a hardware circuit comprising VLSI circuits or gate arrays, logic chips, transistors, or other discrete components. A module may also be implemented in programmable hardware devices such as field programmable gate arrays, programmable array logic, and/or programmable logic devices.

Modules may also be implemented in software for execution by various types of processors. A module of executable code may comprise one or more physical or logical blocks of computer instructions, which may be organized as an object, procedure, or function.

A module of executable code may be a single instruction, or may be many instructions, and may be distributed over several different code segments, among different programs, and across several memory devices. Operational data may be organized with any suitable type of data structure. The operational data may be collected as a single data set, or may be distributed over different locations including over different storage devices. Modules are capable of communication with other modules and databases on the social networking system 201. Modules may receive or provide instructions to other modules or databases on the social networking system 201.

Several of the functional components described are labeled as databases (e.g. 155, 157, 158). Databases may comprise computer readable storage medium stored on one or more servers. Databases may maintain data on the social networking system 201 according to one or more data structures or indexes. Databases are capable of communication with other modules and databases on the social networking system 201. Databases may receive or provide instructions to other modules or databases on the social networking system 201.

FIG. 8 illustrates a high-level diagram showing interaction between communications devices of a host 205c, partner 205b, and user 205a, a communications network 208, and a social networking system 201 of the embodiment. Communications devices 205a, 205b, 205c may be computers, laptops, cellular phones, tablets, or similar devices. The social networking system 201 may comprise a social networking website, one or more servers operating the social networking website, or any other device or application capable of providing social networking services via the communications network 208.

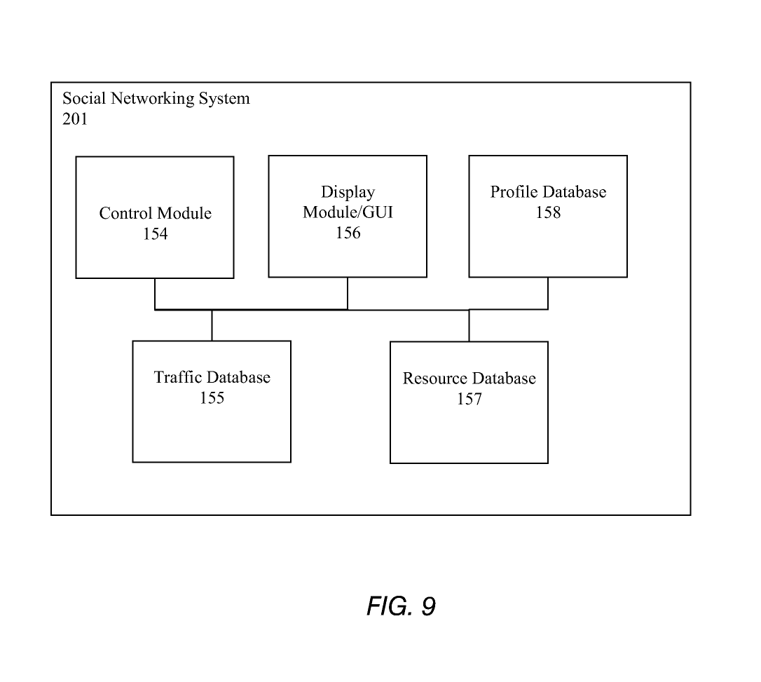

FIG. 9 illustrates a schematic illustration of a social networking system 201. The social networking system 201 has a control module 154, a traffic database 155, a display module 156, a resource database 157, and a profile database 158.

Resource database 157 is provided for storing data pertaining to events, groups, or establishments (resource objects 202) on the social networking system 201. Resource database 157 may create an index of resource objects 202. Each resource object 202 may comprise resource object information 713, amended resource information 712, content data 711, resource object associations 714, as well as type and class of each resource object 202.

Profile database 158 is provided for storing data pertaining to individual users and user profiles. Resource database 158 may create an index of user objects. Each user object may contain personal information about a user (name, email address, location). User objects may also contain user resource associations and user assigned importance, and corresponding threshold for a particular resource object 202, which is stored in user filter data 715 on the profile database 158.

Traffic database 155 is provided for storing mean traffic data for resource objects 202. Traffic database 155 may create an index, with each index relating to mean traffic data for a particular resource object 202.

Display module 156 is provided for displaying a resource display interface 120 on a communications device of a user 105a. Display module 156 is capable of rendering a graphical user interface viewable by the user. For example, display module 156 may display web pages web based templates, or widgets on a browser of a user communications device 105a, 105b, 105c via TCP/IP, HTTP, or other protocol.

Control module 154 is provided for continuously monitoring resource object associations 714 and mean traffic data. Control module 154 identifies changes in resource object associations 714 and mean traffic data for a particular resource object 202 on the social networking system 201. The control module 154 communicates with the traffic database 155, display module 156, resource database 156, and profile database 158 on the social networking system 291. The control module 154 sends an instruction to the display module 156 to update the resource display interface 120. The control module determines 154 whether mean traffic data on the social networking system 201 for a particular resource object 202 exceeds the threshold established by user filter data 715. If the threshold is exceeded, the control module 154 sends an instruction to the display module 156 to transmit a real-time signal to a communications device of a user 205a indicating that changes in activity on the social networking system 101 for a particular resource object 202 exceeds the threshold established by user filter data 715.

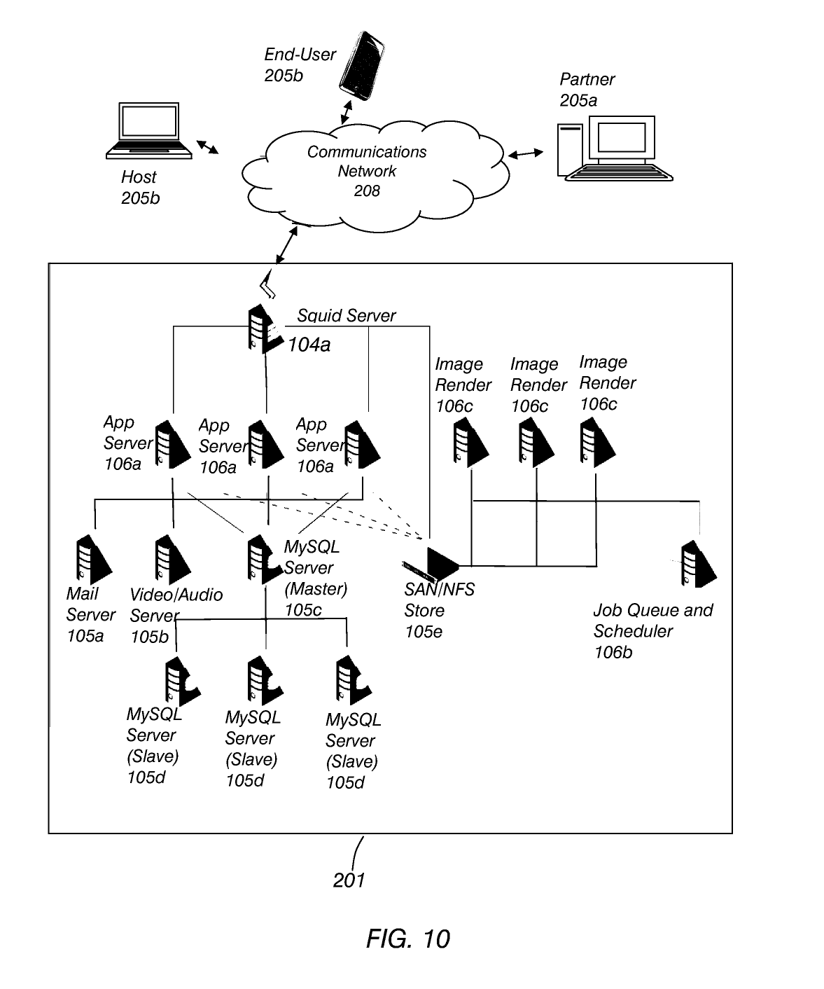

FIG. 10 represents a schematic diagram of detailed view of an exemplary hardware implementation of the social networking system 202. Implementation of the social networking system 202 in such a configuration is shown for illustration, as other configurations are possible. Hardware implementing the control module 154 may comprise a squid server 104a. The squid server 104a is a caching proxy supporting HTTP, HTTPS, FTP, for example. When used in the “HTTPD-accelerator” or reverse-proxy mode, the squid server 104a facilitates setting up multiple application servers that the squid server 104a load balances. The control module 154 may also comprise a job queue and scheduler machine 106b. Hardware implementing the resource database 157, profile database 158, and traffic database 155 may comprise a MySQL master server 105c, and a plurality of MySQL slave servers 105d. Hardware implementing the display module 156 may include a mail server 105a, a video/audio streaming server 105b, a SAN/NFS based store 105e, a plurality of app servers 106a implementing memcached systems, and a plurality of servers implementing image rendering/resizing processes 106c.

### How the Invention is Used

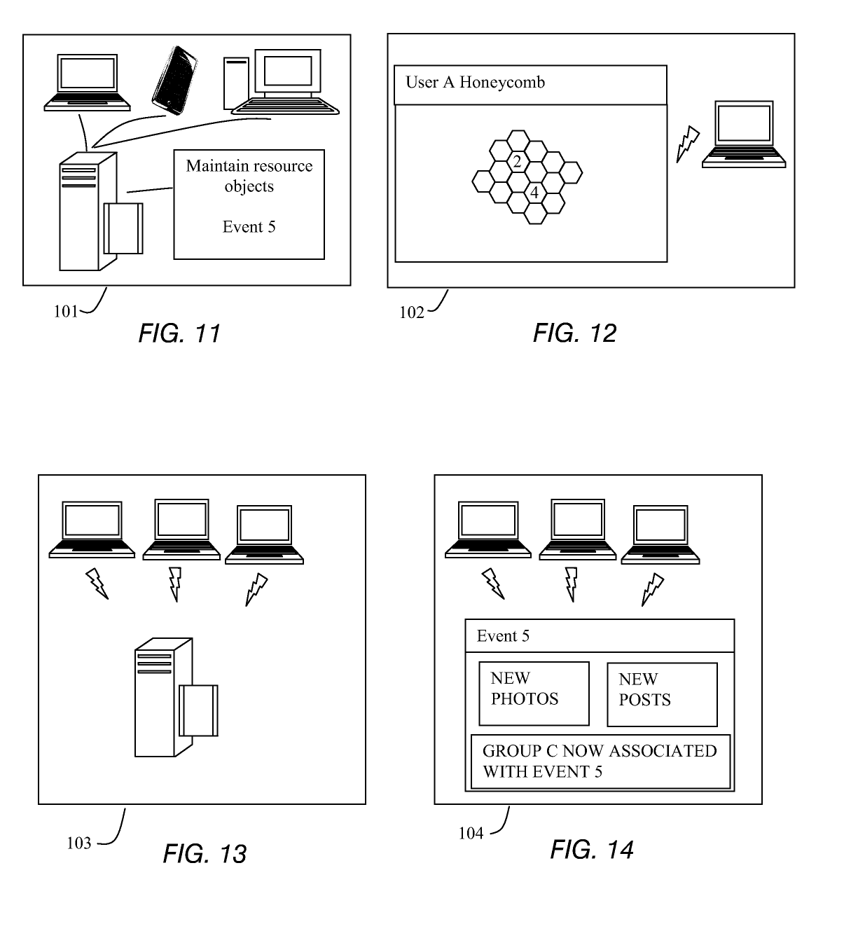

FIGS. 11-19 illustrates an example for providing real-time notification of increased communication in a selected area of interest on a social networking system according to embodiments.

FIG. 11 illustratively shows the social networking system 201 maintaining 101 resource objects 202. As shown, the social networking system 201 maintains “Event 5” on the social networking system 201. In the example, “Event 5” has not yet been associated with other resource objects.

FIG. 12 illustratively shows the social networking system 201 providing 102 a resource display interface 120 on a communications device of “User A”. In the example, “User A” has chosen to associate with sixteen (16) resource objects.

FIG. 13 illustratively shows the social networking system 201 continuously monitoring 103 resource object associations 714 and mean traffic data for resources on the social networking system 201.

FIG. 14 illustratively shows the social networking system 201 identifying changes 104 in resource object associations 714 and mean traffic data for a particular resource object 202. In the example, Event “5” is now associated with “Group C.” New photos and new posts (resource content data) are provided.

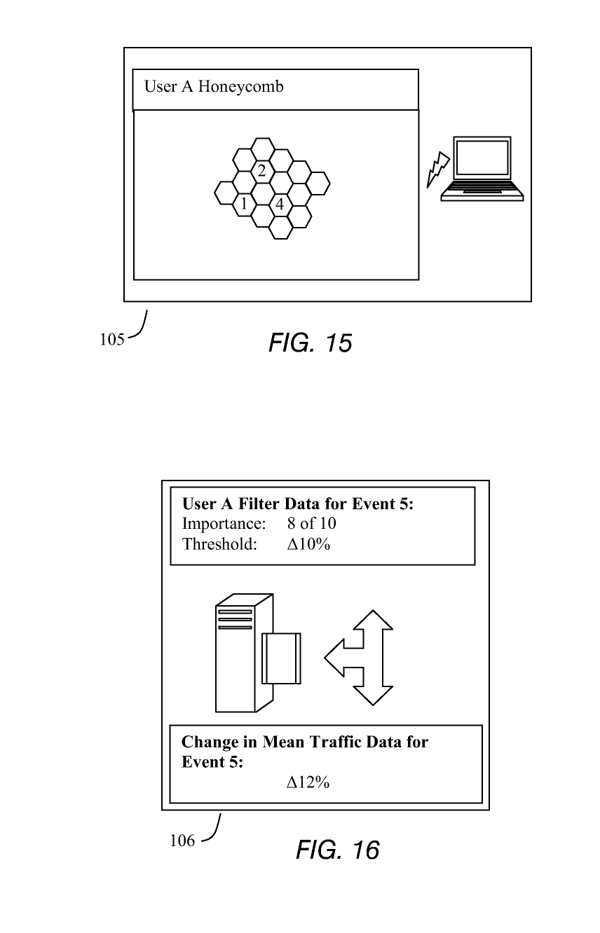

FIG. 15 illustratively shows the social networking system 201 updating 105 the resource display interface 120 of “User A” to display additional resource object associations 714. In the example, “Event 5” has not been associated with “Group C.” Therefore, the numeral “1” is displayed on the user display interface of “User A”.

FIG. 16 illustratively shows the social networking system 201 determining 106 whether mean traffic data on the social networking system 201 for a particular resource object 202 exceeds a threshold established by user filter 715 data for “User A.” In the example, “User A” has specified an importance of 8 of 10 for “Event 5.” The corresponding threshold for “Event 5” is Δ10%. Change in mean traffic data for “Event 5” is determined to be Δ12%. Therefore, the threshold is exceeded for “Event 5.”

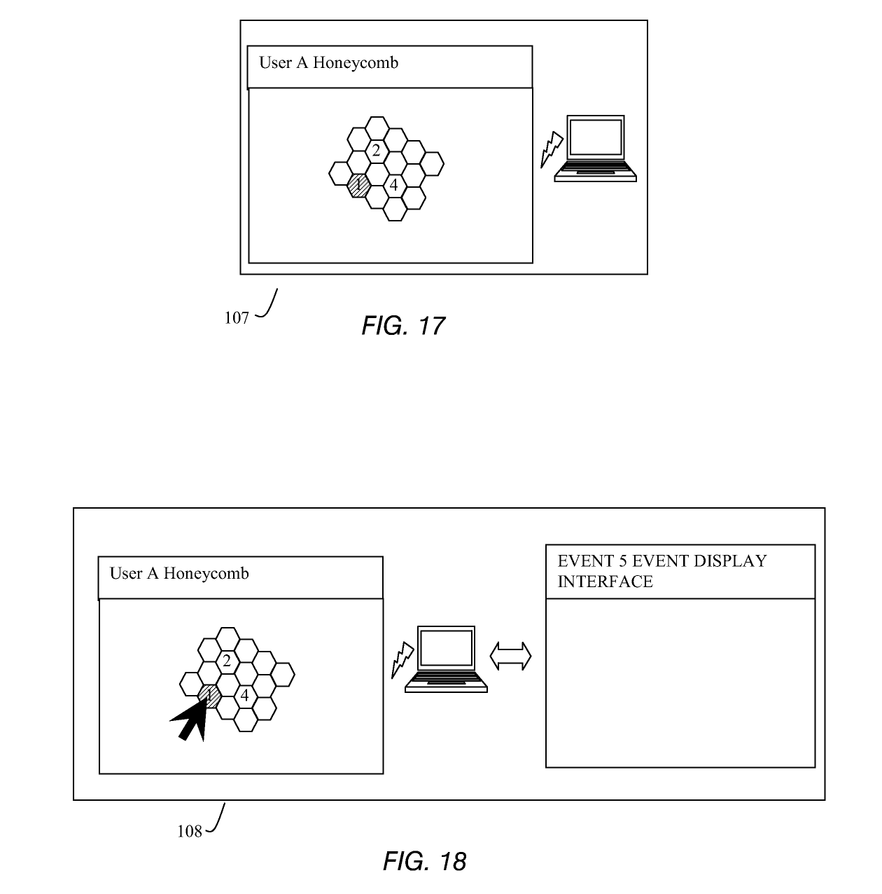

FIG. 17 illustratively shows the social networking system 201 transmitting 107 a real-time signal to the communications device of “User A.” As shown, the honeycomb for “Event 5” flashes.

FIG. 18 illustratively shows the social networking system 201 performing an additional optional step of allowing the user to navigate 108 to a selected resource object. In the example, “User A” clicks on the honeycomb corresponding with “Event 5.” The social networking system 201 then navigates to resource display interface 120 for “Event 5.”

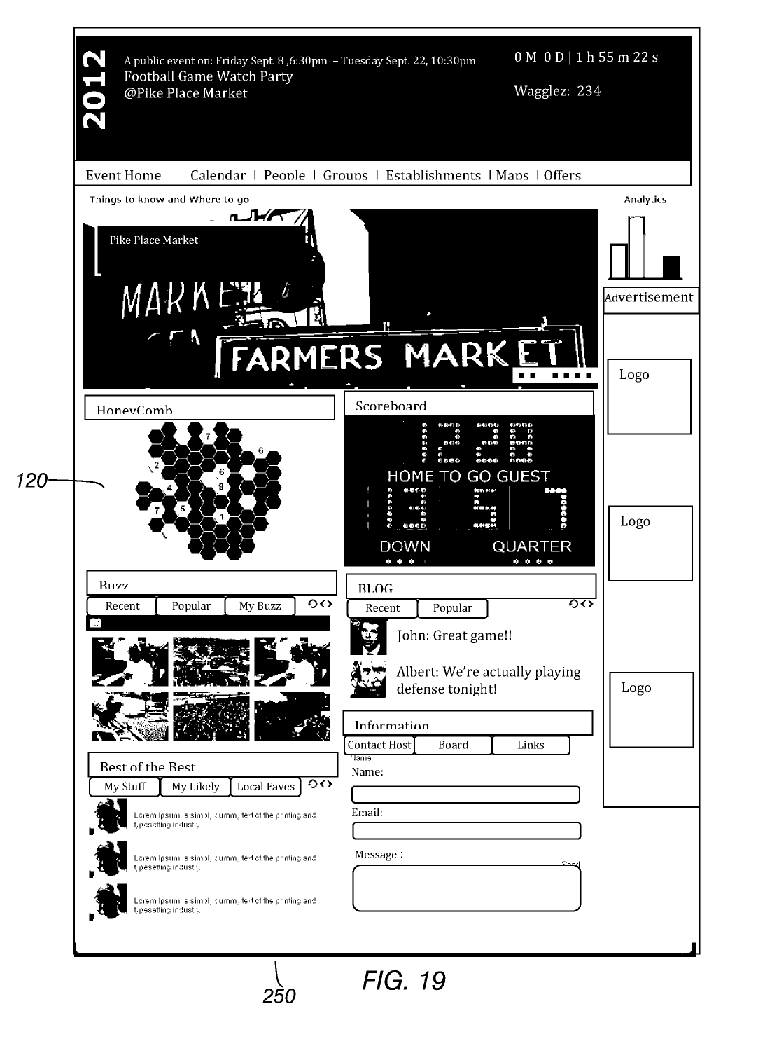

FIG. 19 shows an event user interface 150 displayed on a communications device of a user 105a, showing display of the resource display interface 120 to the user.

### Alternatives

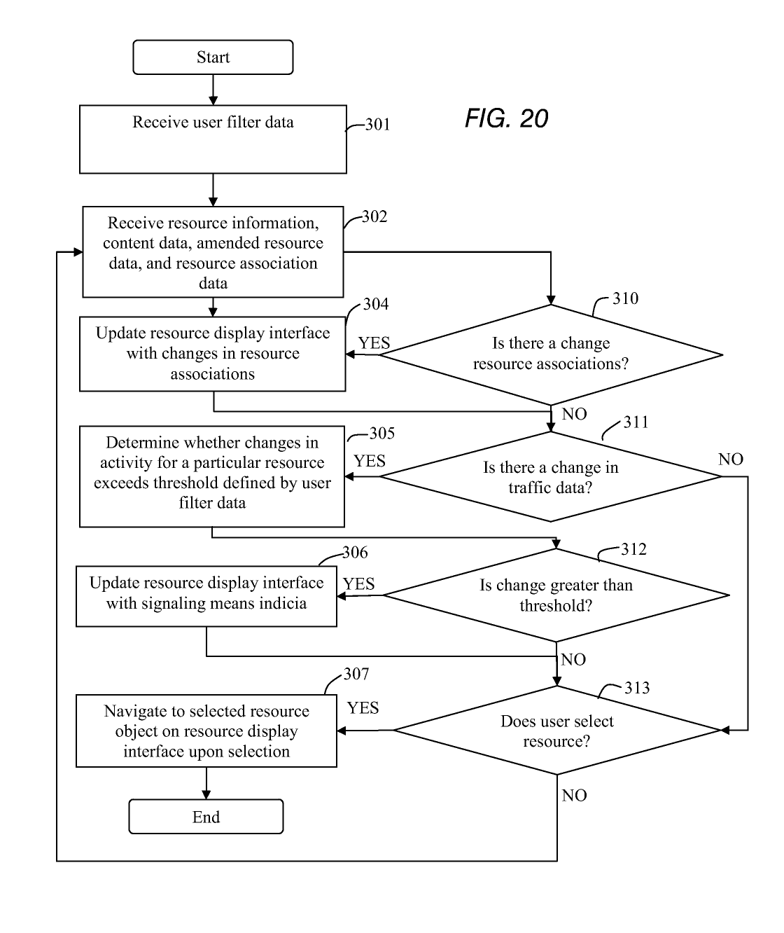

FIG. 20 illustrates a flowchart for a process providing real-time notification of increased communication in a selected area of interest on a social networking system of an alternate embodiment. According to the embodiment, the social networking system receives user filter data at 301. The social networking system receives resource information content data, amended resource data, and resource association data at 302. In step 310, it is determined whether there are changes in resource object association. If so, then processing continues at 304. If not, then process continues to 311. Resource display interface is updated to display changes in resource associations at 304. In step 311, it is determined whether there is a change in mean traffic data. If so, then process continues at 305. If not, then process continues at 313. In step 312, it is determined whether change in mean traffic data is greater than threshold. If so, then process continues at 306. If not then process continues at 313. Resource display interface is updated at 306 to display signaling means indicia. In step 313, it is determined whether user selects a resource object. If so, then process continues at 307. If not, then process returns to 302. User is navigated to resource display interface upon selection of resource object at 307.

Differing combinations and permutations of the embodiments set forth are contemplated by the current invention. Additionally, all functional equivalents are contemplated by the current invention. Therefore, the spirit and scope of the appended claims should not be limited to the descriptions of the preferred versions and alternate embodiments set forth herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A computer implemented method of providing real-time notification of increased communication in a selected area of interest(s) on a social networking system, comprising:
maintaining a plurality of resource objects on a social networking system, wherein each of the resource objects represents an event, group, establishment, or user on the social networking system, and wherein the resource objects are stored as objects on the social networking system,
providing a resource display interface on a communications device of a user, the resource display interface further comprising a graphical user interface capable of displaying: a scalable tessellation of resource objects the user has associated with, a numerical value of the number of associations between resource objects; and a real-time signal on each of the resource objects represented in the resource display interface;
continuously monitoring the number of associations between resource objects and mean traffic data on the social networking system;
identifying changes in the number of associations between resource objects and mean traffic data for a particular resource object the user has associated with on the social networking system;
updating the resource display interface to display the number of associations between resource objects as a numerical value;
determining whether mean traffic data on the social networking system for a particular resource object exceeds a threshold established by user filter data, wherein the threshold represents a minimum percentage of change in activity for the particular resource object which is inversely related to the level of importance assigned to the particular resource object by the user; and
transmitting a real-time signal to a communications device of user indicating that changes in activity on the social networking system for a particular resource object exceeds the threshold established by user filter data.

2. The method of claim 1, further comprising allowing the user to navigate to the particular resource object by selection from the resource display interface.

3. The method of claim 1, wherein the resource display interface comprises a plurality of resource display members representing resource objects the user has chosen to associate with.

4. The method of claim 3, wherein the resource display members are graphically displayed as honeycomb cells, with a plurality of sides and vertices.

5. The method of claim 1, wherein the resource display interface comprises a plurality of resource association indicators graphically representing the number of associations between resource objects as a numerical value.

6. The method of claim 1, wherein mean traffic data represents an activity level of users for a class of resource objects over a time interval.

7. The process of claim 1, wherein transmission of a real-time signal includes displaying a traffic indicia signaling member on the resource display interface.

8. A system for providing real-time notification of increased communication in a selected area of interest(s) on a social networking system, comprising:
a resource database configured to store data pertaining to resource objects on a social networking system;
a profile database configured to store data pertaining to individual user profiles on the social networking system;
a traffic database configured to store mean traffic data for resource objects on the social networking system;
a display interface configured to display a resource display interface on a communications device of a user;
a control module configured to execute a set of instructions for:
maintaining a plurality of resource objects on a social networking system, wherein each of the resource objects represents an event, group, establishment, or user on the social networking system;
providing a resource display interface on a communications device of a user, the resource display interface further comprising a graphical user interface capable of displaying: a scalable tessellation of resource objects the user has associated with, a numerical value of the number of associations between resource objects; and a real-time signal for each of the resource objects represented in the resource display interface;
continuously monitoring the number of associations between resource objects and mean traffic data on the social networking system;
identifying changes in the number of associations between resource objects and mean traffic data for a particular resource object the user has associated with on the social networking system;
updating the resource display interface to display the number of associations between resource objects as a numerical value;
determining whether mean traffic data on the social networking system for a particular resource object exceeds a threshold established by user filter data; wherein the threshold represents a minimum percentage of change in activity for the particular resource object which is inversely related to the level of importance assigned to the particular resource object by the user;
transmitting a real-time signal to a communications device of user indicating that changes in activity on the social networking system for a particular resource object exceeds the threshold established by user filter data;
and wherein the control module is configured to perform job/scheduling and sending/receiving instructions to the control module, a traffic database, display module, resource database, and a profile database during execution.

9. The system of claim 8, further comprising allowing the user to navigate to the particular resource object by selection from the resource display interface.

10. The system of claim 8, wherein the resource display interface comprises a plurality of resource display members representing resource objects the user has chosen to associate with.

11. The method of claim 10, wherein the resource display members are graphically displayed as honeycomb cells, with a plurality of sides and vertices.

12. The system of claim 8, wherein the resource display interface comprises a plurality of resource association indicators graphically representing the number of associations between resource objects as a numerical value.

13. The system of claim 8, wherein mean traffic data represents an activity level of users for a class of resource objects over a time interval.

14. The system of claim 8, wherein transmission of a real-time signal includes displaying a traffic indicia signaling member on the resource display interface.

15. An apparatus comprising a machine readable storage memory storing a program having instructions which when executed by a processor will cause the processor to providing real-time notification of increased communication in a selected area of interest(s) on a social networking system, including instructions for:
maintaining a plurality of resource objects on a social networking system, wherein each of the resource objects represents an event, group, establishment, or user stored as an object on the social networking system, wherein the each of the resource objects are capable of horizontal or vertical relationship with other resource objects on the social networking system;
providing a resource display interface on a communications device of a user, the resource display interface further comprising a graphical user interface capable of displaying: a scalable tessellation of resource objects the user has associated with, a numerical value of the number of associations between resource objects; and a real-time signal for each of the resource objects represented in the resource display interface;
continuously monitoring the number of associations between resource objects and mean traffic data on the social networking system;
identifying changes in the number of associations between resource objects and mean traffic data for a particular resource object the user has associated with on the social networking system;
updating the resource display interface to display the number of associations between resource objects as a numerical value;
determining whether mean traffic data on the social networking system for a particular resource object exceeds a threshold established by user filter data, wherein the threshold represents a minimum percentage of change in activity for the particular resource object which is inversely related to the level of importance assigned to the particular resource object by the user; and
transmitting a real-time signal to a communications device of user indicating that changes in activity on the social networking system for a particular resource object exceeds the threshold established by user filter data.

16. The apparatus of claim 15, further comprising allowing the user to navigate to the particular resource object by selection from the resource display interface.

17. The apparatus of claim 15, wherein the resource display interface comprises a plurality of resource display members representing resource objects the user has chosen to associate with.

18. The apparatus of claim 17, wherein the resource display members are graphically displayed as honeycomb cells, with a plurality of sides and vertices.

19. The apparatus of claim 15, wherein the resource display interface comprises a plurality of resource association indicators graphically representing the number of associations between resource objects as a numerical value.

20. The apparatus of claim 15, wherein mean traffic data represents an activity level of users for a class of resource objects over a time interval.

21. The apparatus of claim 15, wherein transmission of a real-time signal includes displaying a traffic indicia signaling member on the resource display interface.
